(19) United States
(12) Patent Application Publication
(10) Pub. No.: US 2010/0164952 A1
(43) Pub. Date: Jul. 1, 2010

(54) STEREOSCOPIC IMAGE PRODUCTION METHOD AND SYSTEM

(76) Inventor: Michael Roderick, Thousand Oaks, CA (US)

Correspondence Address: Ocean Law, 3463 RED BLUFF CT., Simi Valley, CA, 93063, US

(21) Appl. No.: 12/718,978

(22) Filed: Mar. 7, 2010

Related U.S. Application Data
(60) Provisional application No. 61/297,816, filed on Jan. 25, 2010.

(51) Int. Cl. G06T 15/20; G09G 5/02

(52) U.S. Cl. 345/419; 345/589

(57) ABSTRACT

A stereoscopic image production method and system produces left and right eye images from a two dimensional image.

### PRIORITY CLAIM

This application claims the benefit of Provisional Patent Application No. 61/297,816 filed Jan. 25, 2010 by inventor Michael Roderick and entitled STEREOSCOPIC IMAGE PRODUCTION SYSTEM AND METHOD.

### BACKGROUND OF THE INVENTION

1. Field of the Invention

The present invention relates to stereoscopic images. In particular, a digital image file is used to create two digital image files useful in making a stereoscopic video presentation.

2. Discussion of the Related Art

Traditional methods for manipulation of two dimensional image files to create high quality stereoscopic presentations require a time-consuming and expensive conversion process. These methods include steps for one or more of separating objects from frames, painting in spaces left by moved objects, or displacing only selected objects rather than all of the frame contents.

The present invention improves on traditional stereoscopic conversion methods by using modern image processing tools and/or reducing the need for one or more of separated objects, painting in, and displacing less than all of the frame.

### SUMMARY OF THE INVENTION

A sequence of two dimensional images is used to produce corresponding sequences of left and right eye images suitable for stereoscopic viewing.

In an embodiment, a method for producing stereoscopic images comprises the steps of: receiving digital information representing a plurality of frames and objects within the frames where the frames are intended to be presented to viewers as a sequence of frames; selecting a sequence of frames having at least a portion of a particular object in common; selecting a frame from the sequence of frames; in a layer corresponding to the frame, identifying selected objects within the layer; indicating the relative depth of the objects in the layer corresponding to the frame by assigning to each identified object a shade of gray corresponding to the object's depth; creating a composite image for each frame by adding the selected frame on top of the layer corresponding to the frame; adjusting the opacity of the top layer to a value in a range of less than one hundred percent or, in an embodiment, about ten to twenty percent; adding detail with a soft-light transform; blurring the composite image; creating a left eye image by displacing the entire composite image to the left as indicated by the gray scale layer; creating a right eye image corresponding to the left eye image by displacing the entire composite image to the right as indicated by the gray scale layer; and, rendering out the left and right eye images to create left and right eye frames capable of being viewed as a stereoscopic presentation of the selected sequence of frames.

In various embodiments, objects are identified by one or more of direct or indirect tracing, chroma keying, luminance keying, and tracking.

In an embodiment, depth assignments are automated using a pseudo-random function to automatically assign depths within a selected range of depths. In some embodiments, gradient ramps are used in assigning depths.

In some embodiments an object is separated from the selected frame and, in a layer containing the separated object, depths are assigned to features of the object. In an embodiment, the separated object layer is added beneath the selected frame to create a composite image having as many as three layers.

### BRIEF DESCRIPTION OF THE DRAWINGS

The present invention is described with reference to the accompanying figures. These figures, incorporated herein and forming part of the specification, illustrate embodiments of the invention and, together with the description, further serve to explain its principles enabling a person skilled in the relevant art to make and use the invention.

FIG. 1 shows a flow chart of a stereoscopic image production method and system in accordance with the present invention.

FIG. 2 shows an object identification and depth assignment step of the stereoscopic image production method and system of FIG. 1.

FIG. 3 shows an object separation step of the stereoscopic image production method and system of FIG. 1.

FIG. 4 shows an add-back step of the stereoscopic image production method and system of FIG. 1.

FIG. 5 shows a tool selection step of the stereoscopic image production method and system of FIG. 1.

FIG. 6 shows a depth map of the stereoscopic image production method and system of FIG. 1.

FIG. 7 shows left and right eye images based on a depth map of the stereoscopic image production method and system of FIG. 1.

FIG. 8A shows a pre-processing original image of the stereoscopic image production method and system of FIG. 1.

FIG. 8B shows an image with outlines of the stereoscopic image production method and system of FIG. 1.

FIG. 8C shows an image with an enlarged outline of the stereoscopic image production method and system of FIG. 1.

FIG. 8D shows an image with gray scale objects of the stereoscopic image production method and system of FIG. 1.

FIG. 8E shows an image of a depth map of the stereoscopic image production method and system of FIG. 1.

FIG. 8F shows an image of a composite image of the stereoscopic image production method and system of FIG. 1.

FIG. 8G shows an image of a blurred composite image of the stereoscopic image production method and system of FIG. 1.

FIG. 8H shows an image of a collage of images of the stereoscopic image production method and system of FIG. 1.

### DETAILED DESCRIPTION OF THE PREFERRED EMBODIMENTS

The disclosure provided in the following pages describes examples of some embodiments of the invention. The designs, figures, and description are non-limiting examples of certain embodiments of the invention. For example, other embodiments of the disclosed systems and methods may or may not include the features described herein. Moreover, disclosed advantages and benefits may apply to only certain embodiments of the invention and should be not used to limit the disclosed inventions.

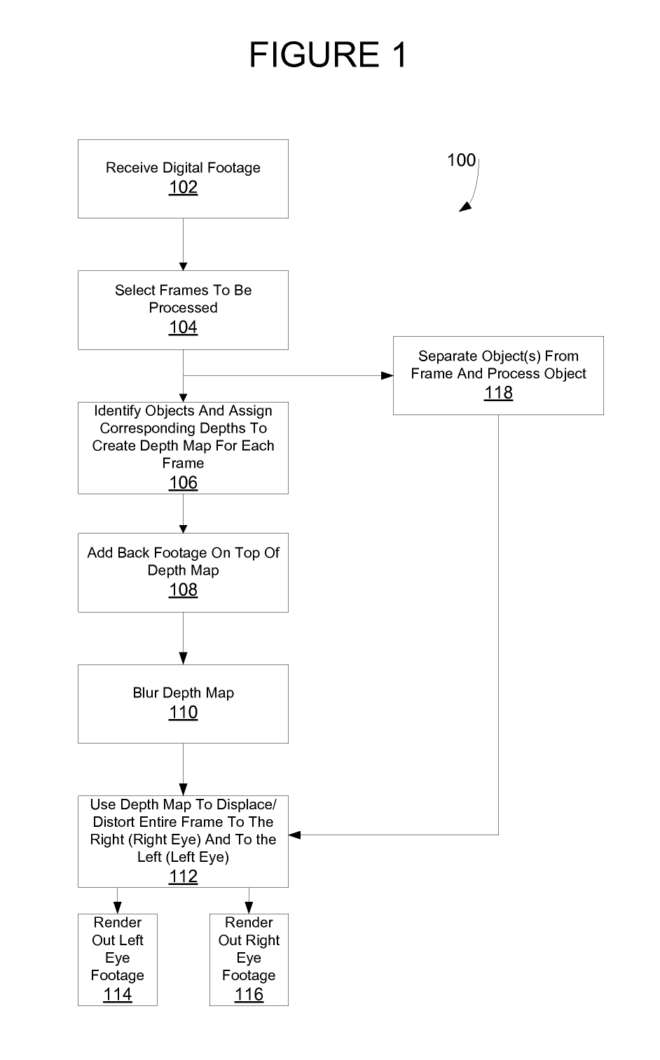

FIGS. 1-5 show method steps in the form of a flow diagram. FIG. 1 shows stereoscopic image production method in accordance with the present invention 100. Digital footage is received 102 and from the digital footage frames to be processed are selected 104. Objects within each of the selected frames are identified and corresponding depths are assigned to the objects 106. In various embodiments, object selection and/or depth assignment is manual, automated or semi-automated. The result of this process is creation of a depth map.

In an embodiment, objects within a selected frame are identified such that the collection of the identified objects incorporates the entire frame. The identification process may be direct using a computerized tool or, for a few objects, it may be indirect in that it is inferred from the direct identification of adjacent objects which bound it.

As described herein, frames, images and/or objects are in various embodiments comprised of information in a single layer or multiple layers. For example, an image may comprise a layer including an object separated from the original frame and another layer including other objects from the original frame.

In various embodiments, the depth map is depth indicating information associated with a particular layer. In some embodiments, the depth map information appears to the user as a gray scale image where bright objects are in or near the foreground and dark objects are further away in or near the background.

In an embodiment, creation of the depth map, all or a part of the frame is blurred 110. In one embodiment, the entire image is blurred, for example by using a fast blurring tool. In another embodiment, an individual object or layer containing one or more objects is blurred.

After creation of the depth map, the originally selected frames are added back on top of the corresponding depth map frames to produce composite frames 108. The depth map is then used to displace/distort the composite frames to the right, producing a right eye image, and to the left, producing a left eye image 110. The left eye image is rendered out as a first digital file 112 and the left eye image is rendered out as a second digital file 114.

In an embodiment, one or more of the selected frames 104 are processed by separating out and processing particular objects 116 before the displacement/distortion step 110.

Digital footage is received in a manner known to persons of ordinary skill in the art 102. In an embodiment, footage is received from a file and in an embodiment digital footage is received from a video capture device such as a video camera without first being written to a file. Digital image formats include one or more of Advanced Authoring Format (“AAF”), Compressed Audio (“AC-3”), Advanced Systems Format (“ASF”), Audio Video Interleaved (“AVI”), Cinepak, Digital Cinema Initiative (“DCI”), Digital Cinema Initiative Distribution Master (DCDM”), DivX, Digital Picture Exchange (“DPX”), Digital Theater Systems (“DTS”), DV (Digital Video”), Flash, SWF, FLV, MPEG, Indeo, J2K C, MP4, Material Exchange Format (“MXF”), QuickTime, RealVideo, Sorenson, and Windows Media (“MF”).

Footage often includes many frames embodying a large number of shots and/or related sequences of frames. In cases, creation of stereoscopic outputs is simplified, such as through increased automation of the process, by dividing the footage into multiple sections of related footage or multiple shots. For example, the frames of a particular shot are selected and then processed as a group. These and other methods of selecting frames to be processed are used in various embodiments 104.

In an embodiment, an operator using a digital computer running imaging software uses software tools to perform computer assisted steps including the identification and/or depth assignment steps 106. In various embodiments, a digital processor or computer using suitable software known to persons of ordinary skill in the art, such as one or more of Adobe® After Effects®, Fusion™ by Eyeon, and Nuke™ by The Foundry, is used. Where a software tool is mentioned herein, tools having similar functions in these software applications are included.

In an embodiment, objects in a frame are identified and assigned depths to create a frame depth map 106. For example, in a layer corresponding to the frame, selected objects are identified and a relative depth is indicated for each object.

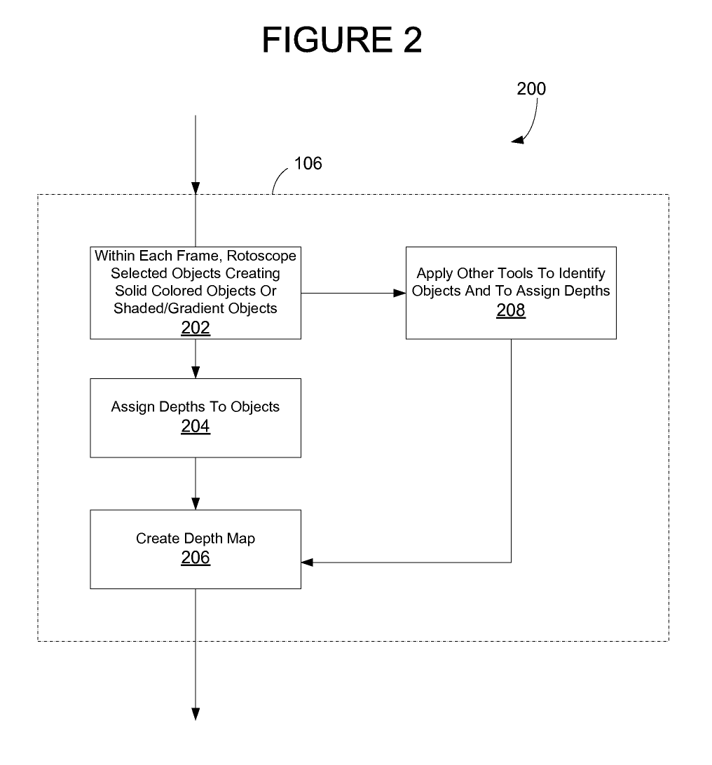

FIG. 2 shows a depth map creation method 200. Within each frame or layer corresponding to the frame, selected objects are outlined using for example rotoscoping tool(s) 202. Objects identified in this manner are assigned depths 204 and this collection of information is used to assemble a corresponding depth map 206. In some embodiments, humans perceive and assign depth as when humans view selected objects in the context of the frame and assign a depth such as a relative depth to the objects.

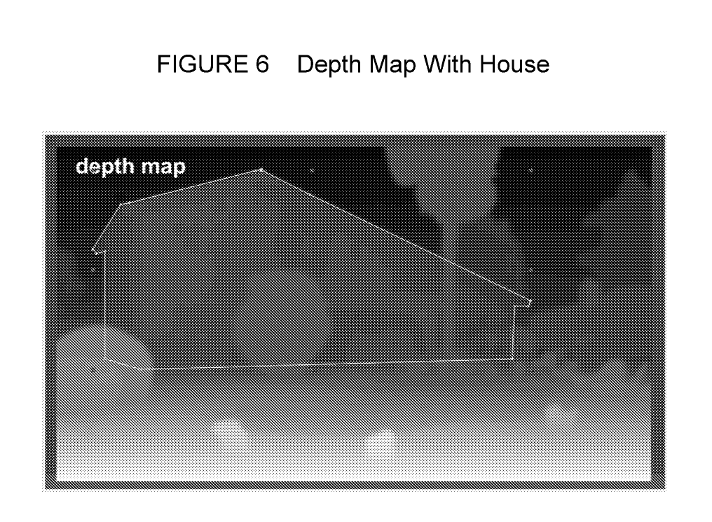

FIG. 6 shows a depth map in the form of gray scale representation of frame objects and their depth indicated by the shade of gray 600. Objects in the depth map include a house, shrubs, and trees. Moreover, the house is traced around with straight line segments showing a rotoscoping process used to identify objects.

Tools other than rotoscope tools are, in various embodiments, used in conjunction with rotoscope tools or alone to outline objects 208. In addition, in various embodiments, tools other than human depth perception are used in conjunction with human depth perception or alone to assign a depth to a selected object.

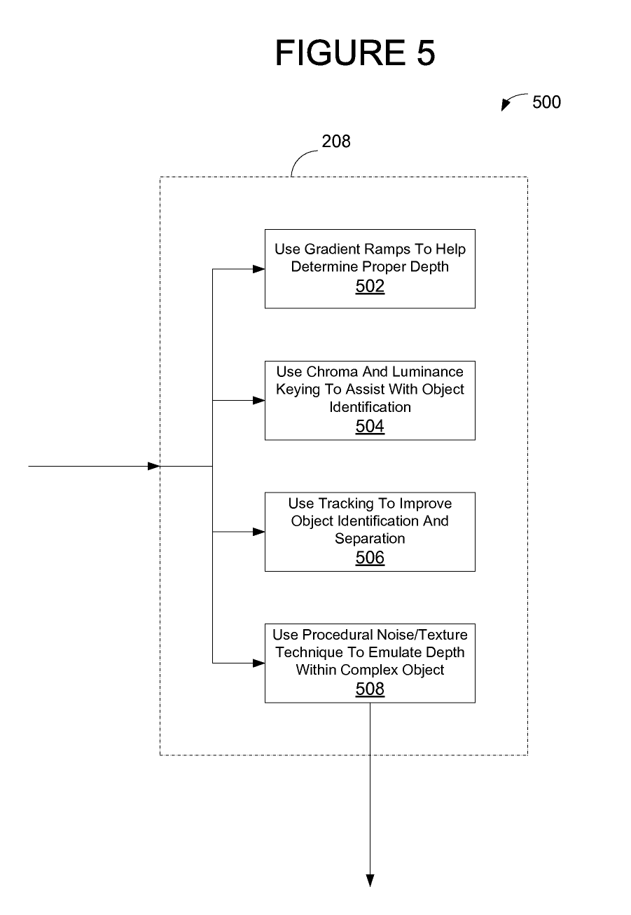

FIG. 5 shows tools other than rotoscoping useful for object identification and depth assignments 500. For example, chroma and luminance keying based on the color and brightness of an object assists with or automates identification of an object and/or its outline where these object features distinguish the object from its surroundings.

When moving from one frame to another, some embodiments include use of software tracking tools. Use of tracking tools improves object identification and separation 506. For example, a tracking marker associated with a particular feature of an object enables tracing of an object or drawing of a mask once and animation or automatic application of that tracing or mask on subsequent frames.

In various embodiments, varying depths within a selected object are emulated by techniques that automate depth assignments such as by the use of a random or pseudo-random function to assign depths within a given range of depths. Procedural noise and texture techniques made available by corresponding software tools are used in some embodiments for this purpose 508.

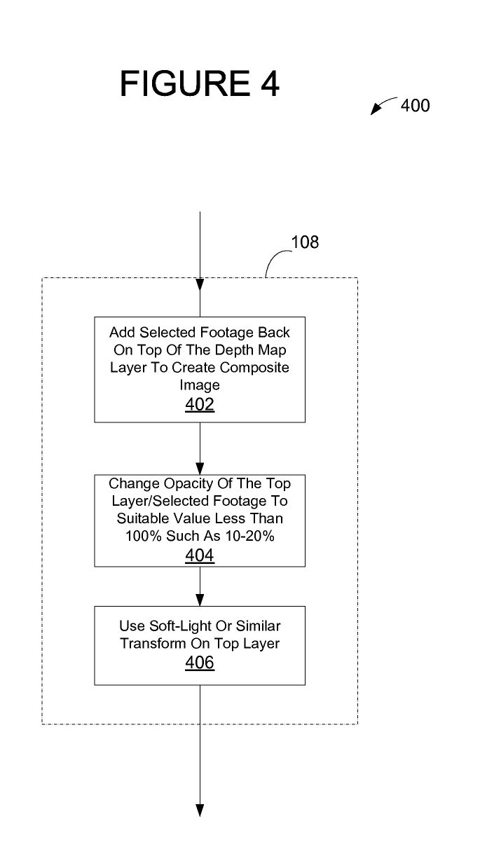

After creation of the depth map 106, footage is added back on top of a depth map 108. FIG. 4 shows the add-back process 400. Frame by frame, a footage layer is added back on top of a corresponding depth map layer to produce a composite image 402.

After this addition, the opacity of the top layer is adjusted to a suitable value using an opacity tool 404. Suitable values provide for some show-through of the depth map layer, in particular values less than 100% opacity. In an embodiment, opacity values in the range of 5 to 40% are selected. In another embodiment, opacity values in the range of 10 to 20% are selected.

A transform mode or tool for adding additional detail is used on the top layer after the opacity is adjusted 408. For example the soft-light tool is often a suitable tool for this purpose. Other transform modes and/or tools used for adding additional detail include normal, screen additive, overlay, difference, and other tools performing similar functions.

In a step using a blurring tool, all or a part of the composite image is slightly blurred to produce a blurred composite image 112. In an embodiment, the blurring tool is used to smooth image transitions. And, in an embodiment, the entire image is blurred, for example by using a fast blurring tool. In another embodiment, an individual object and/or layer containing one or more objects is blurred.

The blurred composite image is used in producing displaced versions of the footage 112. Here, the depth map is used by a displacement or distortion tool to indicate displacements of the entire frame to the right and to the left. Frames are displaced/distorted to the left for producing left eye images and the frames are displaced to the right for producing right eye images.

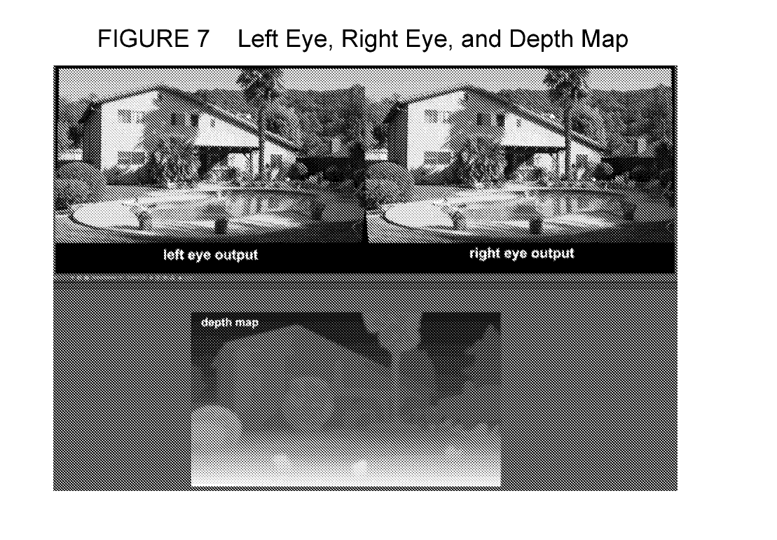

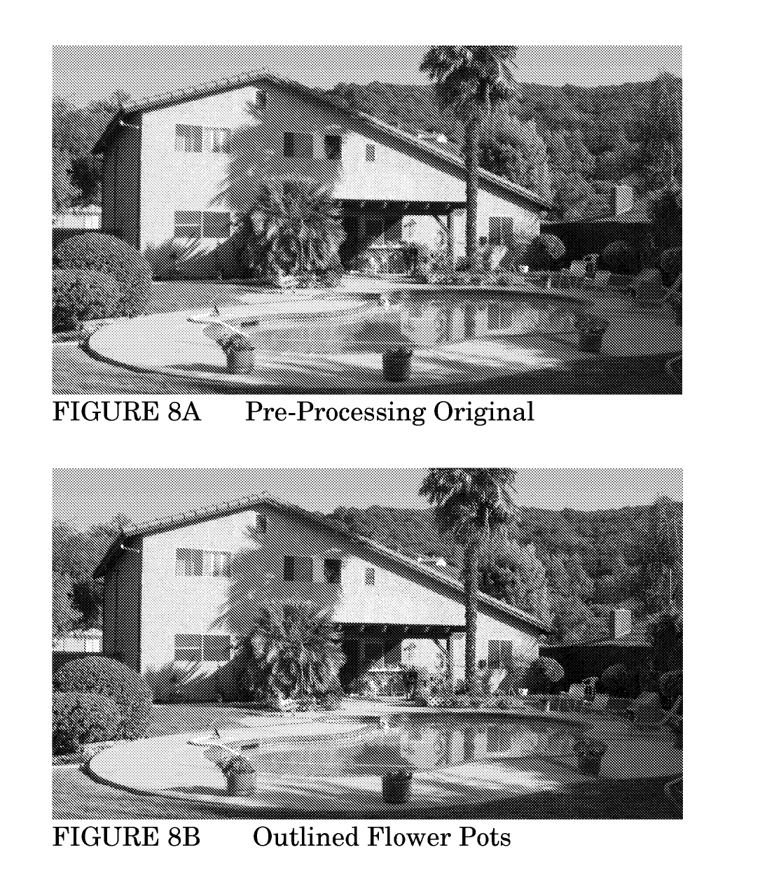

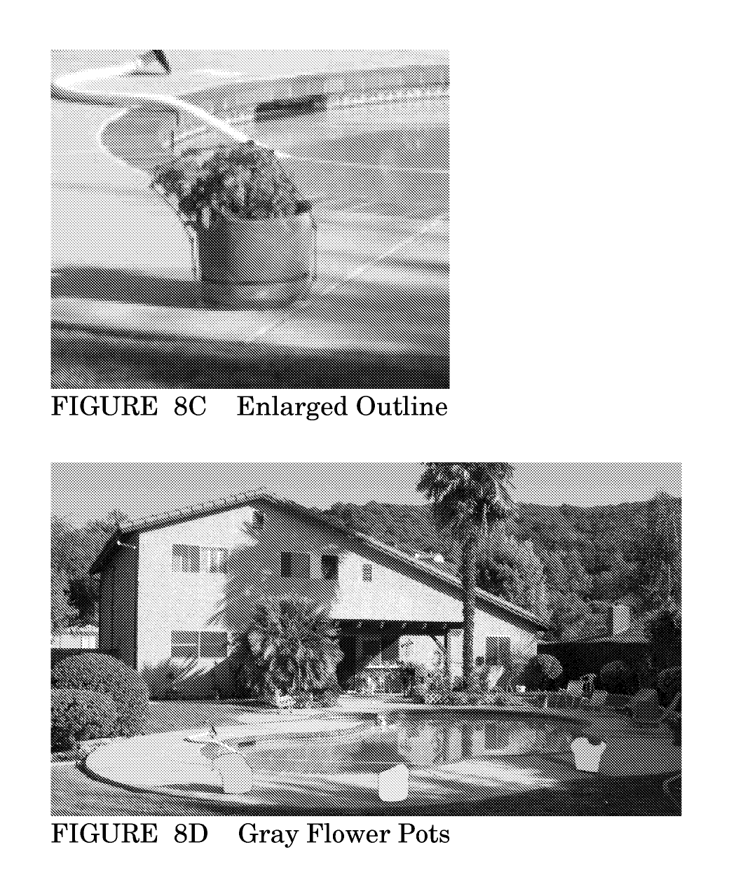

FIG. 7 shows the outputs from a displacement/distortion process on a particular frame. The image at the bottom of the figure is a depth map that is applied to a corresponding original frame (not shown) using a displacement tool. In one application, a displacement to the left produces the left eye output shown at left. In a second application, a displacement to the right produces the right eye output shown at right.

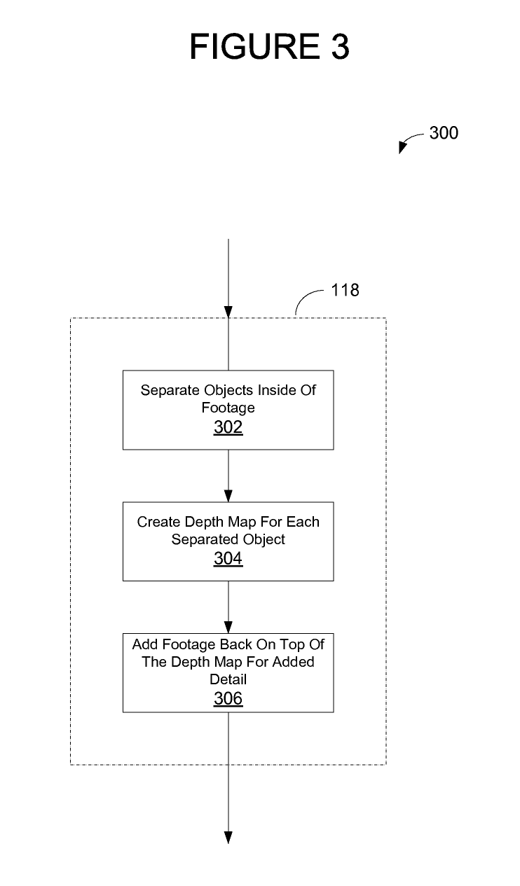

FIG. 3 shows an embodiment for processing special objects 300. Here, one or more of the selected frames 104 are processed by separating out and processing particular objects 116 before the displacement/distortion step 110. This embodiment provides, for example, an alternative means for processing a complex object having features at varying depths such as a large tree with branches distributed from a near field to a far field. In an embodiment, a layer containing the processed special object is added beneath the original frame to create a three layer composite image. In some embodiments, the procedural noise and texture techniques discussed above are used to assign depths for such an object.

Here, objects are separated or removed from the context of their surroundings 302. Once removed, a depth map for the separated object is created 302. The footage is then added back on top of the depth map to obtain added detail 306. The output from this process is received by the displacement/distortion step 112.

The frames displaced/distorted to the left are rendered out as left eye footage 114 and the frames displaced/distorted to the right are rendered out as right eye images. In an embodiment, two dimensional DPX frames processed in the present invention result in stereoscopic left and right eye frames in DPX format.

A view screen illuminated by two projectors showing superimposed left and right eye images provides a stereoscopic viewing experience. In particular, polarized 3D glasses create the illusion of three-dimensional images by restricting light that reaches each eye, a method of stereoscopy exploiting the polarization of light. This is used to produce a three-dimensional effect by projecting the same scene into both eyes, but depicted from slightly different perspectives.

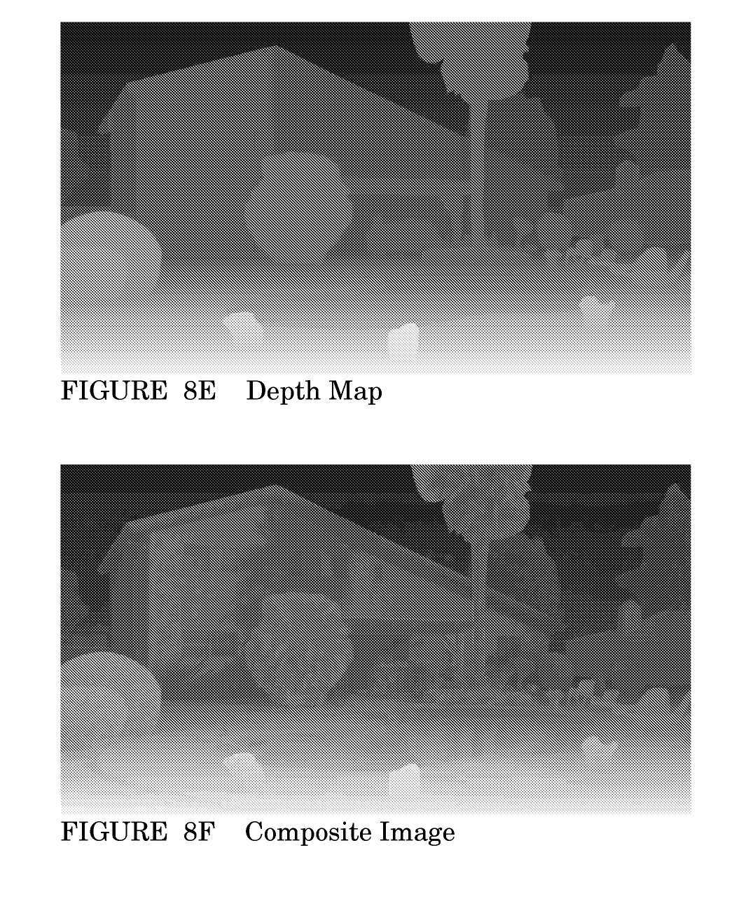

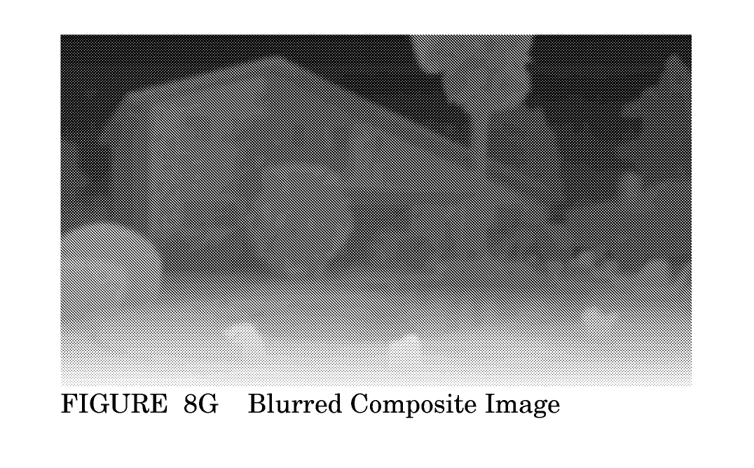

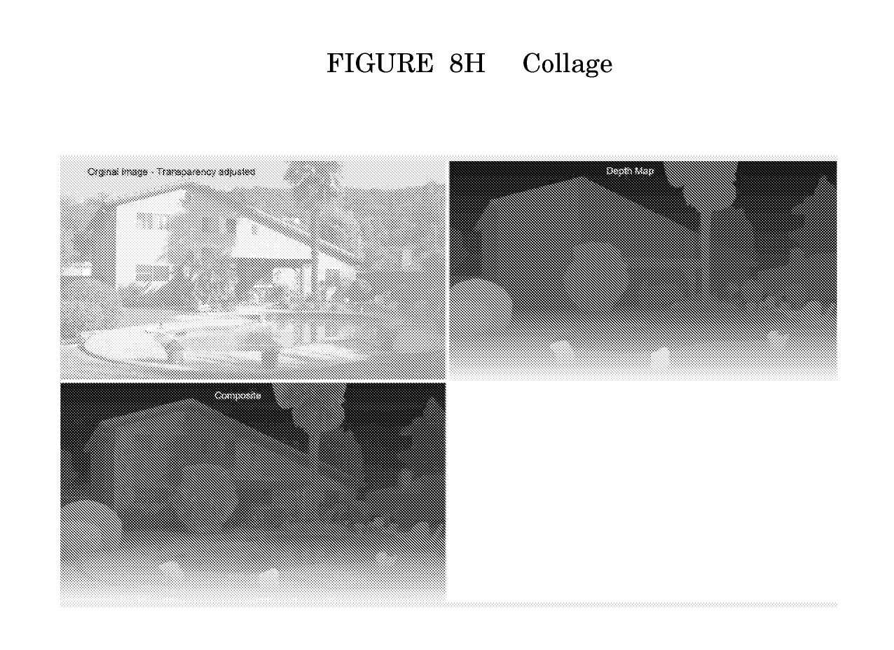

FIGS. 8A-G show selected processing steps for a single frame. As will be understood by a person of ordinary skill in the art, the sequence of steps may in cases be varied from the sequence shown. These variations depend on factors including the sequence of frames being processed, the subject matter of particular frames, and the process user's judgment and preference.

FIG. 8A shows a before processing original of a selected frame with flower pots in the foreground, mountains in the background and a swimming pool and house in between.

FIG. 8B shows identification of the flower pots by directly or indirectly tracing an outline around each flower pot. FIG. 8C shows an enlarged view of the left-most flower pot where the outline is more clearly visible.

FIG. 8D shows the outlined flower pots in gray scale. The identification and tracing steps are repeated for additional objects in the frame and, in an embodiment, the traced objects substantially fill the frame (as shown). Relative depths are indicated for the traced objects by assigning to each object a shade of gray corresponding to the object's depth; the choice of when to perform depth assignments depends, inter alia, on the process user's judgment.

FIG. 8E shows a depth map derived at least in part from the above steps. In an embodiment, at least a preliminary depth map results from assigning depths to each of the traced objects.

FIG. 8F is a composite image for the selected frame. The composite image is produced by adding the original frame back on top of a corresponding gray scale layer that is the completed depth map or a gray scale layer derived from the completed depth map.

FIG. 8G shows a blurred composite image produced by blurring the composite image with a blurring tool. In an embodiment, a fast blurring tool is used to produce the blurred composite image. As explained above, steps including creation of left and right eye images and rendering out left and right eye images follow.

FIG. 8H shows a collage of images arranged side-by-side for comparison. As can be seen, objects in the foreground (the flower pots) appear lighter in the depth map and composite image than objects in the background (mountains).

The present invention has been disclosed in the form of exemplary embodiments; however, it should not be limited to these embodiments. Rather, the present invention should be limited only by the claims which follow where the terms of the claims are given the meaning a person of ordinary skill in the art would find them to have.

What is claimed is:

1. A method for producing stereoscopic images comprising the steps of:
receiving digital information representing a plurality of frames and objects within the frames, the frames intended to be presented to viewers as a sequence of frames;
selecting a sequence of frames having at least a portion of a particular object in common;
selecting a frame from the sequence of frames;
in a layer corresponding to the frame, identifying selected objects within the layer;
in the layer corresponding to the frame, indicating a relative depth for each of the identified objects;
creating a multi-layer composite image for each frame, the composite image having a top layer;
adjusting the opacity of the top layer to a value greater than about five percent;
blurring the composite image;
creating a left eye image and a right eye image derived from the composite image;
rendering out left and right eye images to create left and right eye frames intended for viewing during a stereoscopic presentation of the selected sequence of frames.

2. The method of claim 1 wherein the layer corresponding to the frame is a gray scale layer.

3. The method of claim 1 wherein at least a portion of the layer corresponding to the frame is a gray scale portion.

4. The method of claim 3 wherein objects are identified by directly or indirectly tracing an outline around each object.

5. The method of claim 4 wherein the identified objects substantially fill the layer.

6. The method of claim 5 wherein relative depth is indicated by assigning to each object a shade of gray corresponding to the object's depth.

7. The method of claim 6 wherein the composite image is created by adding the selected frame on top of the layer corresponding to the frame.

8. The method of claim 7 wherein the left eye image is created by displacing the entire composite image to the left as indicated by the composite image.

9. The method of claim 8 wherein the right eye image is created by displacing the entire composite image to the right as indicated by the composite image.

10. A method for producing stereoscopic images comprising:
receiving digital information representing a plurality of frames and objects within the frames, the frames intended to be presented to viewers as a sequence of frames;
selecting a sequence of frames having at least a portion of a particular object in common;
selecting a frame from the sequence of frames;
in a layer corresponding to the frame, identifying selected objects within the layer;
indicating the relative depth of the objects in the layer corresponding to the frame by assigning to each identified object a shade of gray corresponding to the object's depth;
creating a composite image for each frame by adding the selected frame on top of the layer corresponding to the frame;
adjusting the opacity of the top layer to a value in a range of about ten to twenty percent;
adding detail with a soft-light transform;
blurring the composite image;
creating a left eye image by displacing the entire composite image to the left as indicated by the gray scale layer;
creating a right eye image corresponding to the left eye image by displacing the entire composite image to the right as indicated by the gray scale layer; and,
rendering out the left and right eye images to create left and right eye frames capable of being viewed as a stereoscopic presentation of the selected sequence of frames.

11. The method of claim 10 wherein objects are identified by chroma keying.

12. The method of claim 10 wherein objects are identified by luminance keying.

13. The method of claim 10 wherein objects are identified by a tracking tool.

14. The method of claim 10 wherein depth assignments are automated using a pseudo-random function to automatically assign depths within a selected range of depths.

15. The method of claim 10 further including the steps of:
separating an object from the selected frame;
in a layer containing the separated object, assigning depths to features of the object; and, adding the separated object layer beneath the selected frame to create a composite image having three layers.

16. The method of claim 15 wherein depth assignments are automated using a pseudo-random function to automatically assign depths within a selected range of depths.
